(19) United States
(12) Patent Application Publication
(10) Pub. No.: US 2013/0282601 A1
(43) Pub. Date: Oct. 24, 2013

(54) COUNTERFEIT PRODUCTS DETECTION METHODS AND SYSTEM

(71) Applicant: Kenneth H. Pieri, Grand Island, NY (US)

(72) Inventor: Kenneth H. Pieri, Grand Island, NY (US)

(21) Appl. No.: 13/898,234

(22) Filed: May 20, 2013

Related U.S. Application Data
(63) Continuation-in-part of application No. 13/450,659, filed on Apr. 19, 2012.

(51) Int. Cl. G06Q 30/00

(52) U.S. Cl. CPC G06Q 30/0185
USPC 705/318

(57) ABSTRACT

A counterfeit product detection method and system for detecting whether a product is genuine or counterfeit. The method allows a consumer to check whether a product is authentic or counterfeit by way of using a sequential serial number assigned to the particular product by the manufacturer of the product. Alternatively, the authenticity of the product can be verified at the point of purchase at the retailer or over the telephone by way of the sequential serial number. The method provides a way for a manufacturer's recall to reach the consumers who purchase the product. There is also a RFID tag product verification method and system provided that allows consumers to verify the authenticity of a product based on the RFID tag that is adhered to the product and/or part of the product packaging. A two dimensional barcode verification product verification method and system is also provided.

### CROSS REFERENCE TO RELATED APPLICATIONS

This application is a continuation in part of co-pending U.S. Non-Provisional patent application Ser. No. 13/450,659 filed on Apr. 19, 2012, which claims priority to U.S. Provisional Patent Application No. 61/476,987 filed on Apr. 19, 2011, and the entire disclosures of each are hereby incorporated herein by reference.

### BACKGROUND OF INVENTION

The speed and ease at which products can be quickly manufactured and subsequently shipped around the world is remarkable. In this respect the world is becoming a smaller place. Unfortunately, this also facilitates the counterfeiting of goods and products by an increasing number of counterfeiters. These counterfeiters are becoming more and more savvy at counterfeiting. Counterfeit goods have also long been a source of problems and concerns in the industries of clothing, accessories, wrist watches, hand bags, suitcases, movies, music recordings, et cetera. One of the serious problems associated with counterfeited products is that they look and feel the same as the authentic products, and have matching colors, sizes, weights and markings that are exactly the same as the authentic products, but are not genuine. In addition, the counterfeited products have external and internal packaging that is exactly the same as the authentic product packaging. One of the main problems with these products is that the consumer and the manufacturer are badly cheated. Both suffer losses. The consumer receives poor quality, which in many cases, is the cause of a shortened life of the product and the manufacturer loses profits.

In addition, there is usually an enormous difference in the price between the counterfeited product and the authentic product. Thus, it is quite possible that the counterfeiter makes more money on the counterfeited product, than the legitimate manufacturer makes on its own product. This fact alone provides counterfeiters with an enormous incentive to copy various products, along with the packaging.

Another problem with some counterfeited products is that, depending on the product, it could be very dangerous and unsafe for consumers, such as a fire extinguisher or smoke alarm products.

What is needed is a way to stave off the serious dangers of these counterfeit products. It would be desirable to have a simple method for the consumer to determine whether or not the product is genuine or counterfeit. It would also be desirable for the method to be quick and easy to use and relatively inexpensive for the consumer to verify whether or not a particular product is or is not counterfeit.

### SUMMARY OF THE INVENTION

This counterfeit detection method provides a way for consumers to verify whether a product is genuine or counterfeit. This is accomplished by having the manufacturer attach a unique, sequential serial number for each unit of production, such as for each handbag, wristwatch or even a pair of pants. This same invention could be utilized for thousands of other consumer products.

In the first step, it is recommended that the consumer obtain a “permanent” personal identification (ID) number similar to a Social Security number. For example, the personal ID number would have at least five or more digits with a combination of letters and numbers obtained from an international registry office that has a website dedicated for such an identification number, and the website may have a name such as “Idnumbers.net” that will be owned an operated by this patent holder. The personal ID number would be a permanent personal positive identification number for the purchasing consumers (such as “AJK321”).

A personal ID number should be used when contacting the manufacturer of a product. However, it would not be required unless the consumer would like to also register with the manufacturer for warranty purposes, especially in the case of a defect with the product (at some later date), when a “Recall” is necessitated by the manufacturer or if the product is stolen and assistance in the possible recovery of the product is desired. Each product would have its own sequential serial number sewn into it, embossed on it, laser marked (such as in the case of a wrist watch) on it, or attached in some manner. Many products such as televisions, cell phones, computers, et cetera already have serial numbers.

The invention could be embodied as a computer verification method, a telephone verification method, a radio frequency identification (RFID) tag verification method, and/or a one or two dimensional barcode verification method.

### Computer Verification Method (FIG. 1)

In one of the preferred embodiments, the consumer or the retailer would go to the manufacturer's website and enter the manufacturer's identification number and the sequential serial number of the product “before” he or she purchases the product. The purchaser would then wait for the manufacturer's email reply to confirm the authenticity of the product. Alternatively the consumer could use his or her own computer or smart phone to obtain an authentication of the product via email from the manufacturer before the sale.

### Telephone Verification Method (FIG. 2)

In another preferred embodiment, the consumer may elect to call a toll free number (provided by the product manufacturer listed on the product itself) and directly contact the product manufacturer and obtain verbal approval or rejection of the legitimacy of the product.

### Manufacturer's Recall System

In the event of a manufacturer's “recall”, the serial numbered system would allow the manufacturer to locate and/or contact the consumer and resolve the problem, provided that the consumer registered his or her pin number I.D. with the manufacturer.

### Radio Frequency Identification (Hereinafter Referred to as RFID) Tag Verification (FIG. 3)

In another preferred embodiment, the product is provided with an RFID tag that is adhered to the inside or outer surface of the product (and/or product packaging) or disposed beneath the product packaging. If the consumer has a smart phone that includes an RFID reader component and activates the RFID tag, this would cause the RFID tag to transmit an encrypted signal that would send data to the mobile device. The mobile device has access to the Internet and the encrypted signal data is transmitted to the manufacturer over the Internet. The manufacturer has an encryption data key that allows it to access the encrypted data. The manufacturer can immediately determine whether the product is authentic or genuine and transmits a response back to the mobile device. The consumer immediately knows whether or not the product is genuine or counterfeit.

### Two Dimensional Barcode (Matrix Code) Verification (FIGS. 4 and 5)

In another preferred embodiment the product is provided with a two dimensional barcode. The consumer could have a smart phone that includes an image sensor capable of reading two dimensional bar codes. The user scans the two dimensional bar code and compares scanned data that is encrypted, and the encrypted data is transmitted to a decryption center operated by the manufacturer. The manufacturer's decryption center transmits a message to the smart phone as to whether or not the product scanned, is genuine. Two dimensional codes are commonly referred to, in the industry, by the trademark QR Code®, which is a registered trademark of Denso Wave Incorporated Corporation, Japan; Apr. 2, 2012, Toranomon, Minatoku, Toykyo, Japan.

In another preferred embodiment, the above-described method can be modified so that the product is provided with a one dimensional barcode.

### BRIEF DESCRIPITION OF THE DRAWING FIGURES

FIG. 1 is a flow chart showing a first embodiment of the counterfeit product detection method wherein the authenticity of a product is verified via computer verification.

FIG. 2 is a flow chart showing a second embodiment wherein the authenticity of a product is verified by via telephonic verification.

FIG. 3 is a diagrammatic view wherein the product has a RFID tag attached to it and a mobile device is provided for activating the RFID tag.

FIG. 4 is a diagrammatic view wherein the product has been printed, thereon, a two dimensional bar code.

FIG. 5 is a front view of a one dimensional bar code.

### DESCRIPTION

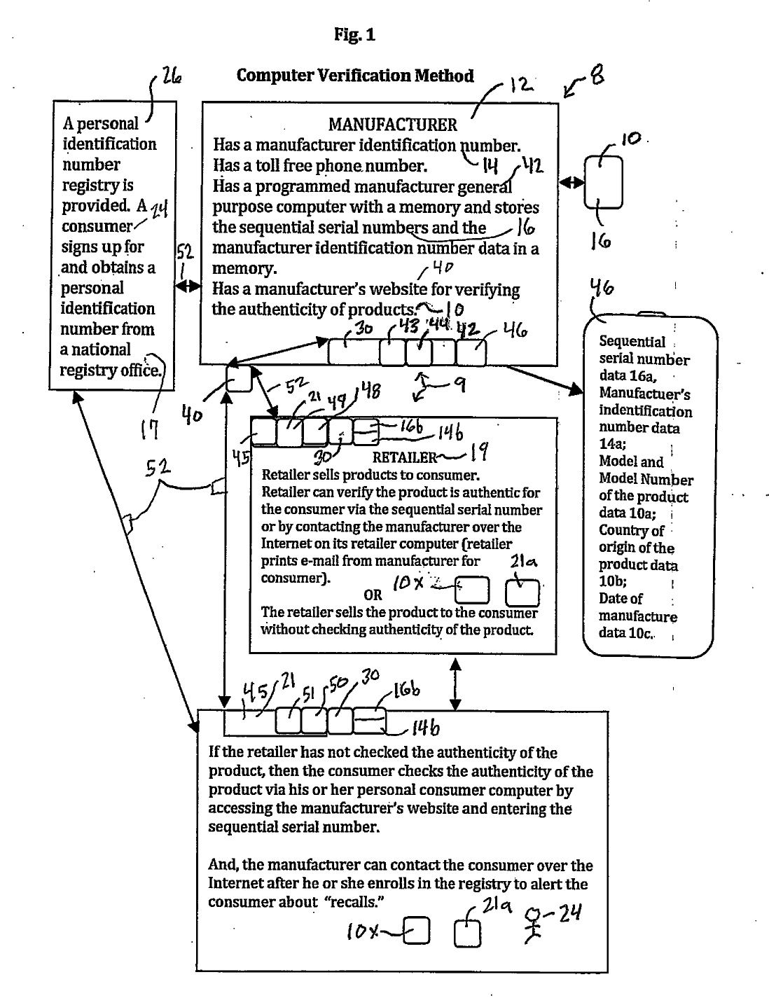

### Computer Verification (FIG. 1)

FIG. 1 is flow chart showing a method and system for detecting counterfeit products 8. As shown, the method begins with the manufacturer 12 of product 10. The manufacturer 12 shall have its own manufacturer's identification number 14. The manufacturer 12 assigns a unique sequential serial number 16 to each product 10 that it manufactures. These products 10 are authentic or non-counterfeit. For example, if the products 10 made by the manufacturer are wristwatches, then the manufacturer 12 will assign to each wristwatch its own unique sequential serial number 16. The manufacturer's identification number 14 and the sequential serial number 16 can include letters, numerals and combinations of letters and numerals.

In one of the preferred embodiments the sequential serial number 16 and the manufacturer's identification number 14 are each created in such a manner that they “do not” include the letters B, C, D, E, M, N, P, T, V, Z. The reason for this is that these letters usually lead to confusion when they are pronounced because they may sound like a different letter.

For each product 10 made by the manufacturer 12 the following information or data pertaining to the product 10 will be created and saved or stored by the manufacturer 12, namely:

a) the sequential serial number 16 assigned to that product 10 (sequential serial number data 16a);

b) the manufacturer's identification number 14 (manufacture's identification number data 14a);

c) the model and model number of the product 10 (model and model number of the product data 10a);

d) the country of origin of the product 10 (country of origin product data 10b);

g) the date of manufacture of the product 10 (date of manufacture data 10c)

e) the website address for the manufacturer 12; and,

f) the toll free number of the manufacturer 12.

Prior to making a purchase the consumer 24 should first obtain a “permanent” personal identification (ID) number 26 similar to a Social Security number with, for example, five or more digits or a combination of letters and numbers, from a national registry office 17 set up for the purpose of providing personal identification (ID) numbers 26 to consumers 24. The consumer 24 can call the national registry office 17 to obtain the personal identification number 26. The personal identification number 26 serves as a permanent positive identification of the purchasing consumer 24. The personal identification number 26 is, in one of the preferred embodiments, created so as not to include the letters B, C, D, E, M, N, P, T, V, Z for the reasons described above. The consumer 24 can contact and register with a national registry 17 (for example, the above-mentioned Idnumbers.net) and obtain a personal identification number 26 in one of the preferred embodiments.

When the manufacturer 12 manufactures the product, it attaches the sequential serial number 16 to the product 10. This may be accomplished in a plurality of ways. For example, the manufacturer 12 can laser etch the sequential serial number 16 directly on a surface of the product 10, or can stamp the sequential serial number 16 into, or onto, the product 10, or can sew a tag having the sequential serial number 16 to the product 10, or can attach to the product 10 a sequential serial number 16 with a sticker (if for example, the product is formed from plastic or glass), et cetera.

After shopping at a retailer 19, the consumer 24 goes to the checkout counter with a product 10x, but the authenticity of the product 10x is unknown; that is, it could be authentic or counterfeit. At the point of sale the consumer 24 has two options.

As a first option, the consumer 24 can request the retailer 19 (or a clerk working for the retailer 19) to access or log onto the website 40, of the manufacturer 12, and enter the manufacturer's identification number 14 and the sequential serial number 16. In particular, the retailer 19 uses its own retailer computer 48 to access the website 40 of the manufacturer 12 and inputs the sequential serial number 16 and the manufacturer's identification number 14. The retailer 19 will then be able to provide an immediate verification as to whether the product 10x is or is not an authentic product 10 as soon as the retailer 19 receives a response back from the manufacturer 12. In one of the preferred embodiments, the response from the manufacturer 12 is in the form of an email 21 sent from the manufacturer 12 to the retailer 19. The retailer 19 can read the email 21 displayed on a retailer computer screen display 49 that is used in connection with the retailer computer 48. The retailer 19 can then print the email 21 and provide the consumer 24 with a printed email 21 a indicating whether the product 10x is, or is not, an authentic product 10.

Alternatively, the consumer 24 purchases the product 10x from the retailer 19, goes home, and uses his or her own personal consumer computer 50, to access the website 40 of the manufacturer 12. The consumer 24 then inputs the sequential serial number 16. The manufacturer 12 responds by sending an email 21 to the consumer 24 indicating whether or not the product 10x is, or is not, an authentic product 10. The consumer 24 reads the email 21 on his or her personal consumer computer screen display 51. If the email 21 indicates that the product 10x is counterfeit, then the consumer 24 can return it to the retailer 19 with the printed email 21a that he or she had printed to obtain a refund for the purchase price of the product 10x.

There is also a system 9 provided for carrying out the method for detecting counterfeit products 8. The system 9 includes a programmed manufacturer's general purpose computer 42 having a central processing unit 44 and a memory component 46 that is owned by the manufacturer 12. The memory component 46 is for storing data pertaining to the authentic or non-counterfeited product 10 including at least the following data:

a. sequential serial number data 16a,

b. the manufacture's identification number data 14a;

c. model and model number of the product data 10a;

d. the country of origin of the product data 10b; and,

e. the date of manufacture data 10c.

The memory component 46 is a standard memory component, the use and operation of which are well known to those having ordinary skill in the art, and therefore, is not described in greater detail herein.

The central processing unit 44 uses and processes sequential serial number data 16a, the manufacture's identification number data 14a; model and model number of the product data 10a; the country of origin of the product data 10b; and, the date of manufacture data 10c pertaining to the authentic product 10.

The central processing unit 44 is capable of generating outputs 45.

The central processing unit 44 also uses and processes the sequential serial number data 16b and manufacturer identification number data 14b inputted (by the consumer 14 or retailer 19) pertaining to the potentially counterfeited product 10x, for which the authenticity is in question, and compares the sequential serial number data 16a and the manufacturer's identification number data 14a of the authentic product 10 with the sequential serial number 16b and the manufacturer's identification number data 14b of the product 10x purchased, and creates an output 45 indicating whether or not the product 10x is, or is not, counterfeit. The outputs 45 will display content on a consumer computer screen display 51, the retail computer screen display 49, a manufacturer's screen display 43 and the website 40 operated by the manufacturer 12. The outputs 45 will display of the consumer computer screen display 51, the retail computer screen display 49, a manufacturer screen display 43 and the website 40 operated by the manufacturer 12 can be in the form of a message as to whether or not the product 10x is or is not authentic (or counterfeit). The output 45 can also be in the form of the previously described emails 21 that are to be sent to the retailer computer 48 and the personal consumer computer 50 and then printed out as an email 21a. The above-described screen displays may be embodied as other graphical user interfaces known to those having ordinary skill in the art. Central processing units, and their use and operation, are well known to those having ordinary skill in the art, and therefore, not described in greater detail herein.

In addition, the act of programming a computer, for example the programmed manufacturer general purpose computer 42, to execute instructions in order to carry out the functions described above, is well known to those having ordinary skill in the art, and therefore, is not described in greater detail herein.

There is also an interface component 30 associated with the programmed manufacturer general purpose computer 42 to allow access to the Internet 52. The use and operation of the Internet 52 is well known to those having ordinary skill in the art, and therefore, is not described in greater detail herein.

In particular, the retailer computer 48 and personal consumer computer 50 (that also have interface components commonly designated 30) are in communication with the programmed manufacture general purpose computer 42 by way of interface components 30. The interface components 30 are capable of transmitting and allowing for the flow of incoming and outgoing above-described data, and emails 21 between the programmed general purpose computer 42, the retailer computer 48 and the personal consumer computer 50. The interface components 30 are also for allowing graphical presentations to be viewed on the consumer computer screen display 51 and the retailer computer screen display 49. Interface components 30 are well known to those having ordinary skill in the art and include any combination of hardware, firmware, or software in a computer used to enable communication or data transfer between the computer and a device, system, or network external to the computer. The interface components 30 can connect with a system, or network external to the programmed manufacturer general purpose computer 42, using, for example, a hardwire connection, an optical connection, an Internet connection, or a radio frequency connection. All of these types of connections are well known to those having ordinary skill in the art.

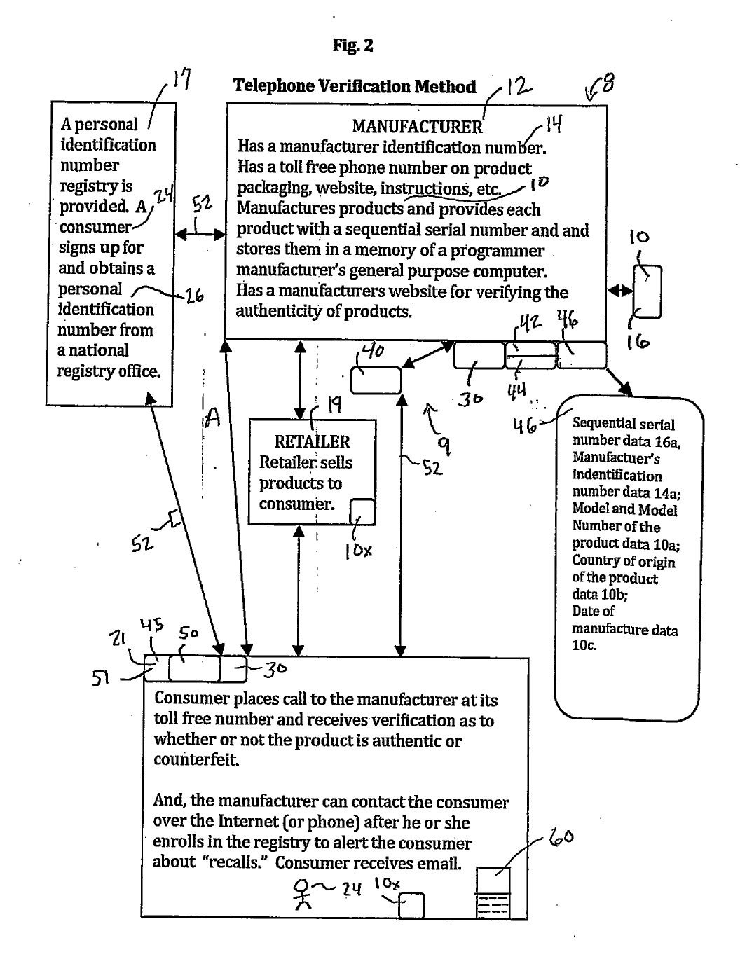

### Telephone Verification Method (FIG. 2)

In another preferred embodiment of the method for detecting counterfeit products 8 is shown in FIG. 2. The consumer 24 purchases the product 10x and then places a call to the manufacturer's 12 toll free number, over his or her phone 60 (indicated by the arrow designated A in FIG. 2). The manufacturer 12 provides the toll free number on its product packaging, in the product instructions or on its website 40. The consumer 24 provides the sequential serial number 16 over the phone 60 to the manufacturer 12, and the manufacturer 12 informs the consumer 24 as to whether or not the product 10x is or is not an authentic product 10.

### Manufacturer's Recall System

As shown in FIGS. 1 and 2, prior to making a purchase, the consumer 24 has the option of first obtaining a “permanent” personal identification (ID) number 26 from the national registry office 17 (or, for example, from a website having a name such as Idnumbers.net). The consumer 24 may call the phone number of the registry office 17, or may register over the

Internet 52. The personal ID number 26 can then be used when contacting the manufacturer 12 of the (authentic) product 10. The personal identification number 26 would not be required unless the consumer would like to also register with the manufacturer 12 for warranty purposes, especially in the case of a defect with the product 10, (at a later date), a “Recall” by the manufacturer 12 or the theft and possible recovery of the product 10.

In the event of a product 10 “recall” by the manufacturer 12, the sequential serial number 16, in combination with the personal identification number 26, would allow the manufacturer 12 to locate and/or contact the consumer 24 and assist the consumer 24 with handling the problem. The manufacturer 12 shall have access to the national registry office 17 (or, for example, from a website having a name such as Idnumbers.net) so as to be able to accomplish such tasks. The manufacturer 12 may call or send an email 21 to the consumer 24 in a manner as described above.

Thus, this unique counterfeit detection method 8 advantageously allows the consumer 24 to purchase products 10x, the authenticity of which are in question, and immediately know whether the products 10x are authentic products 10 in a speedy and reliable manner.

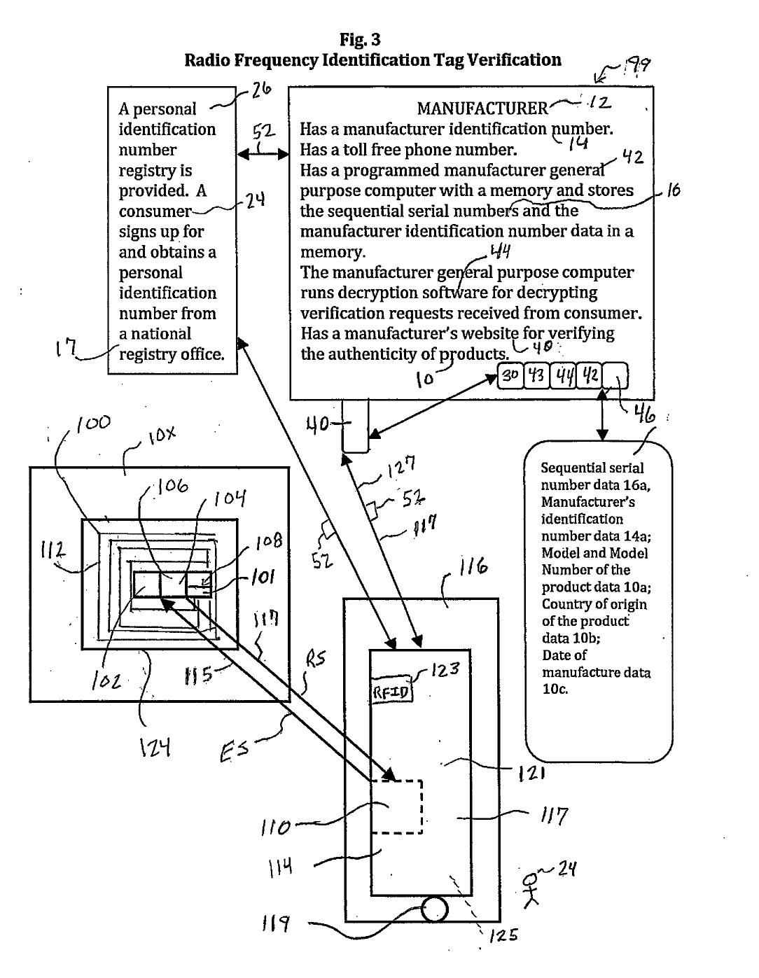

### Radio Frequency Identification Tag Verification (FIG. 3)

In another preferred embodiment, shown in FIG. 3, there is a RFID tag product verification method and system 99 that includes providing an RFID tag 100. The RFID tag 100 includes and radio frequency (hereinafter referred to as RF) transmitter 102 and a RF receiver 104. The RFID tag 100 also has a chip 106 that includes an integrated circuit 108 for storing and processing information such as the product data 101 stored in the RFID tag 100, and for modulating and demodulating RF signals, and for collecting power from the signal transmitted by a RFID reader 110. The RFID tag 100 also has an antenna 112 for receiving and transmitting RF signals. RFID tags and their use, construction and operation are well known to those having ordinary skill in the art and are therefore not described in greater detail herein.

As shown, the RFID reader 110 is part of, or in other words incorporated into, a mobile device 114. In one of the preferred embodiments, the mobile device 114 is a smart phone 116, with an on/off button 119 and screen display 121. The smart phone 116 has its own built-in RFID reader 110. The RFID reader 110 transmits a radio signal 115 (indicated by the arrow designated ES) to the RFID tag 100, and that RFID signal is picked up by the antenna 112 and received by the RF receiver 104. That is, the RFID reader 110 interrogates the RFID tag 100 for information and/or data. In response to the incoming RF signal 115, the RF transmitter 102 sends a response signal (designated RS) 117 to the RFID reader 110. The RFID reader 110 reads all the incoming product data 101 transmitted by the RFID tag 100. In one of the preferred embodiments the product data 101 is encrypted. It is pointed out that in this embodiment, the RFID tag 100 is powered by the RFID reader 110, and thus, is a passive-type RFID tag 100. In other preferred embodiments, the RFID tag 100 could be embodied with its own power source in the form of a battery that activates when in the vicinity of the RFID reader 110. RFID tags, RFID readers and their construction and operation, encrypting and decrypting RFID tags and encryption software programs for use therewith, and storing and retrieving data stored on an RFID tag 100 are well known to those having ordinary skill in the art and are therefore not described herein in greater detail.

The RFID tag 100 is adhered to the product 10x with a suitable adhesive 124 or may be placed in the product packaging, but the authenticity of the product 10x is unknown to the consumer 24. As shown in FIG. 3, the RFID tag product verification method 99 is similar to the verification method previously described in that the manufacturer 12 has its own manufacturer identification number 14 and assigns the unique sequential serial number 16 to each product 10 that it manufactures. For each product 10 made by the manufacturer 12, the previously described following information or data pertaining to the product 10 will be created and then saved or stored by the manufacturer 12, namely:

a) the sequential serial number 16 assigned to that product 10 (sequential serial number data 16a);

b) the manufacturer's identification number 14 (manufacture's identification number data 14a);

c) the model and model number of the product 10 (model and model number of the product data 10a);

d) the country of origin of the product 10 (country of origin product data 10b);

g) the date of manufacture of the product 10 (date of manufacture data 10c)

e) the website address for the manufacturer 12; and,

f) the toll free number of the manufacturer 12.

And, as previously described, the consumer 24 should first obtain a “permanent” personal identification (ID) number 26.

When the manufacturer 12 manufactures the product 10, it attaches the RFID tag 100 to each product 10 by way of adhering RFID tags 100 to its products 10, and/or placing it in the product packaging.

While shopping at a retailer 19, the consumer 24 locates product 10x on the store shelf and needs to determine the authenticity of the product 10x. The consumer 24 takes his or her smart phone 116 and presses the button 119 to turn on his or her smart phone 116. Then the consumer 24 touches an RFID icon 123 displayed on the screen display 121 of the smart phone 116. Once the RFID icon 123 is pressed, the RFID reader 110 activates and is ready to interrogate the RFID tag 100. It is to be understood that a smart phone RFID software program 125 is stored in the smart phone 116 for the purpose of interrogating an RFID tag 100. The RFID reader 110 transmits the incoming RF signal 115 (indicated by arrow designated ES) to the RFID tag 100. That incoming RFID signal 115 is received up by the antenna 112 and directed to the RF receiver 104. In response to the incoming RF signal 115, the RF transmitter 102 sends an encrypted response signal message (designated RS) 117 to the RFID reader 110 disposed in the smart phone 116. The next step is for the consumer 24 to send the encrypted response signal message 117 and any data that is embedded in the encrypted response signal message 117 to the website 40 of the manufacturer 12 for verification purposes. With a smart phone 116, the consumer 24 need only forward the encrypted response signal message 117 to the website 40 of the manufacturer 12 over the Internet 52; for example, as an email or text message.

An authentic product 10 from the manufacturer 12 will have an RFID tag 100 that is encrypted in accordance with the specifications and protocols established by the manufacturer 12, and the manufacturer 12 is the entity that decrypts the incoming response signal messages 117 from consumers 24 pertaining to product 10x authentication. In particular, the above-described central processing unit 44 runs decryption software 130 that decrypts the incoming encrypted response signal messages 117 received from the consumer 24. Next, the manufacturer 12 decrypts the encrypted response signal message 117. The manufacturer 12 can immediately determine whether or not product 10x is or is not authentic by analyzing the information that is part of the encrypted response signal message 117. Thus, upon receipt of the encrypted response signal message 117 from the consumer 24 pertaining to verification of the authenticity of product 10x, the manufacturer 12 decrypts the encrypted response signal message 117. If, upon decryption of the encrypted response signal message 117, the product 10 is indeed determined to be authentic by the manufacturer 12, then the manufacturer 12 sends a verification message 127 in the form of an email or other communication to the consumer 24. Thus, the consumer 24 is provided with proof that the product 10x is actually an authentic product 10. Encryption and decryption software and the use and operation of encryption type software, and writing of encryption and decryption software is well known to those having ordinary skill in the art and is therefore not described herein in greater detail.

If, however, the manufacturer 12 is unable to open the encrypted response signal message 117 received from the consumer 24, then the manufacturer 12 recognizes immediately that the product 10x is a counterfeit product and alerts the consumer 24 that the product 10x is not authentic. If the manufacture 12 is able to open the encrypted product verification request from the consumer 24, and then determines that the product 10x is actually counterfeit because of the known product data, for example sequential serial number data 16a or the manufacturer's identification number data 14a do not match the known sequential serial number data 16a or the manufacturer's identification number data 14a, then the manufacturer 12 sends a message to the consumer 24 that the product 10x for which verification was requested, is not authentic.

Thus, the RFID tag 100 provides for another way to protect consumers 24 by allowing them to purchase only genuine products 10, the authenticity of which has been verified prior to purchase. In addition, the manufacturer 12 can quickly contact the consumer 24 if the product 10x is counterfeit and launch and investigation into what business is selling the counterfeit products.

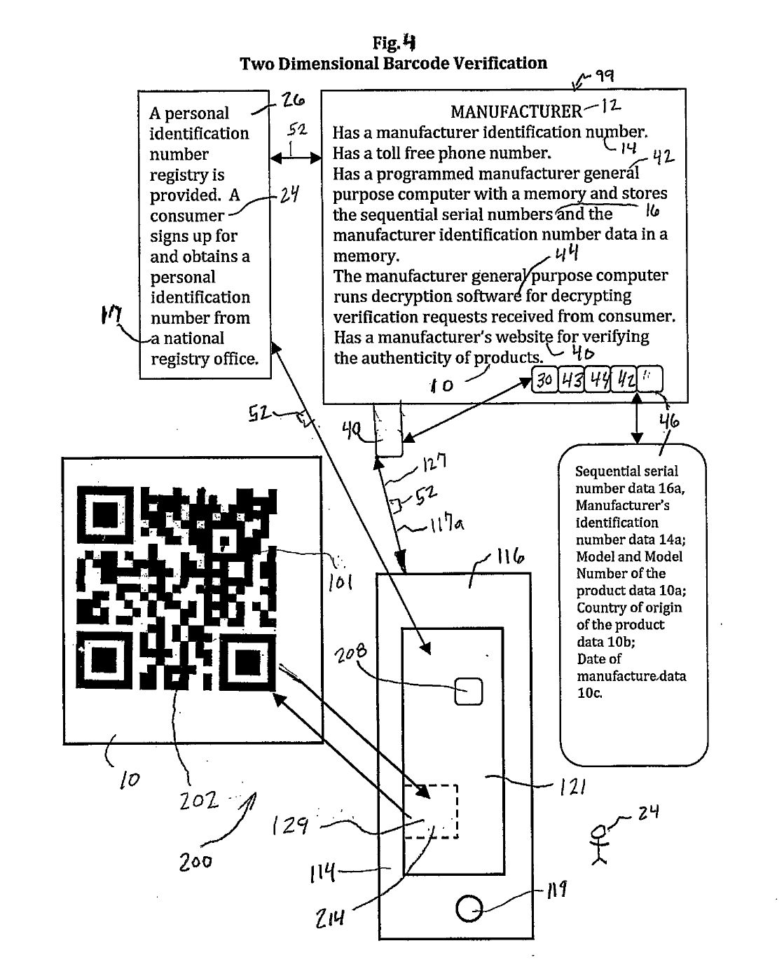

### Two Dimensional Barcode Verification (FIG. 4)

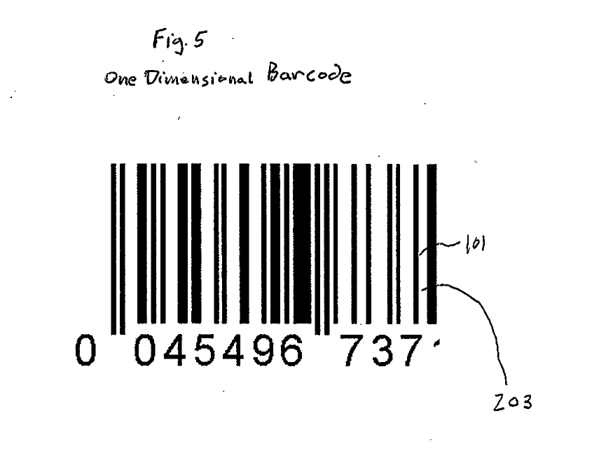

In another preferred embodiment, shown in FIG. 4, there is a two dimensional barcode verification method and system 200 that includes a two dimensional barcode 202. The two dimensional bar code 202 is printed on packaging of the product 10 or is printed on a label adhered to the product 10. In one of the preferred embodiments, the two dimensional barcode 202 is embodied as a quick response code (QR Code®) as described above. It is also pointed out that in another preferred embodiment (see FIG. 5) the two dimensional barcode 202 is replaced with a one dimensional barcode 203 that has a plurality of vertical lines and that is readable by a bar code reading machine.

The two dimensional bar code 202 is a printed representation of product data 101, and this product is readable by an optical scanner machine, also known as a barcode reader. In particular, the mobile device 114 or the smart phone 116, includes an optical scanner 129, and it includes the associated interpretive software that is required to read the two dimensional barcode 202. In particular, the owner of the smart phone 116 need only download a software application to his or her smart phone 116, such that the screen display 121 of the smart phone 116 displays a two dimensional barcode scanning icon 208. As an alternative, the smart phone 116 can be constructed so as to be pre-programmed to optically scan two dimensional bar codes 202, such that the two dimensional bar code scanning icon 208 appears on the screen display 121 at the time of purchase of the smart phone 116.

Barcodes, two dimensional bar codes 202 and one dimensional bar codes 203 and optical scanners and software for interpreting these barcodes, and their use, construction and operation are well known to those having ordinary skill in the art and are therefore not described in greater detail herein.

As previously mentioned, the smart phone 116 scans the two dimensional barcode 202 and it reads all the product data 101 printed thereon. In one of the preferred embodiments, the product data 101 is encrypted. Although the product 10x has a two dimensional barcode 202, the authenticity of the product 10x is unknown to the consumer 24. Two dimensional barcode 202 verification method 200 is similar to the verification method described above in that the manufacturer 12 has its own manufacturer identification number 14 and assigns the unique sequential serial number 16 to each product 10 that it manufactures. For each product 10 made by the manufacturer 12 the previously described following information or data pertaining to the product 10 will be created and saved or stored by the manufacturer 12 as follows:

a) the sequential serial number 16 assigned to that product 10 (sequential serial number data 16a);

b) the manufacturer's identification number 14 (manufacture's identification number data 14a);

c) the model and model number of the product 10 (model and model number of the product data 10a);

d) the country of origin of the product 10 (country of origin product data 10b);

g) the date of manufacture of the product 10 (date of manufacture data 10c)

e) the website address for the manufacturer 12;

f) the toll free number of the manufacturer 12; and,

g) optionally, information pertaining to the identity and street address of the retailer that receives and sells the product 10.

And, as previously described, the consumer 24 should first obtain a “permanent” personal identification (ID) number 26.

When the manufacturer 12 manufactures the product 10 it attaches the two dimensional barcode 202 to each product 10 by way of adhering tags to its products 10 or printing directly on the packaging of the product 10.

In use, while shopping at a retailer 19, the consumer 24 locates product 10x on the store shelf and will need to determine the authenticity of the product 10x. The consumer 24 takes his or her smart phone 116 and presses the button 119 to turn on his or her smart phone 116. Then the consumer 24 touches the two dimensional barcode scanning icon 208 displayed on the screen display 121 of the smart phone 116. Once the two dimensional barcode scanning icon 208 is pressed, the user manually moves the smart phone 116 until it signals the two dimensional barcode 202 has been read by the optical scanner 129 of the smart phone 116. It is to be understood that a smart phone optical scanning software program 214 is stored in the smart phone 116 for the purpose of scanning the two dimensional barcode 202. The next step is for the consumer 24 to send the scanned encrypted product data 101 to the website 40 of the manufacturer 12 for verification purposes. With a smart phone 116, the consumer 24 need only forward the scanned encrypted product data 101to the website 40 of the manufacturer 12 over the Internet 52, for example as an email or text message.

An authentic product 10 from the manufacturer 12 will have a two dimensional barcode 202 that is encrypted in accordance with the specifications and protocols established by the manufacturer 12, and the manufacturer 12 is the entity that decrypts the incoming emails and text messages from consumers 24 pertaining to product 10x authentication. In particular, the above-described central processing unit 44 runs decryption software 130 that decrypts the incoming encrypted messages 117a received from the consumer 24. Next, the manufacturer 12 decrypts the encrypted messages 117a. The manufacturer 12 can immediately determine whether or not product 10x is or is not authentic by analyzing the information that is part of the encrypted message 117a. Thus, upon receipt of the encrypted message 117a from the consumer 24 pertaining to verification of the authenticity of product 10x, the manufacturer 12 decrypts the encrypted message 117a. If, upon decryption of the encrypted message 117a, the product 10 is indeed determined to be authentic by the manufacturer 12, then the manufacturer 12 sends a verification message 127 in the form of an email of other communication to the consumer 24. Thus, the consumer 24 is provided with proof that the product 10x is actually an authentic product 10. Encryption and decryption software and the use and operation of encryption type software, and writing of encryption and decryption software is well known to those having ordinary skill in the art and is therefore not described, herein, in greater detail.

If, however, the manufacturer 12 is unable to open the encrypted message 117a received from the consumer 24, then the manufacturer 12 recognizes immediately that the product 10x is a counterfeit product and alerts the consumer 24 that the product 10x is not authentic. Or, if the manufacturer 12 is able to open the encrypted message 117a from the consumer 24, and then determines that the product 10x is actually counterfeit because of the known product data, for example, sequential serial number data 16a or the manufacturer's identification number data 14a do not match the known sequential serial number data 16a or the manufacturer's identification number data 14a, then the manufacturer 12 sends a message to the consumer 24 that the product 10x, for which verification was requested, is not authentic.

Thus, the two dimensional barcode 202 provides for another way to protect consumers 24 by allowing them to purchase only genuine products 10, the authenticity of which has been verified prior to purchase. In addition, the manufacturer 12 can quickly contact the consumer 24 if the product 10x is counterfeit and launch an investigation into which business is selling the counterfeit products.

It will be appreciated by those skilled in the art that, while a counterfeit product detection method and system 8, a RFID tag product verification methods and system 99, and a two dimensional barcode verification method and system 200 have been described in detail herein, the invention is not necessarily so limited and other examples, embodiments, uses, modifications, and departures from the embodiments, examples, uses, and modifications may be made without departing from the counterfeit product detection method 8, the RFID tag product verification method and system 99, and the two dimensional barcode verification method and system 200 all such embodiments are intended to be within the scope and spirit of the appended claims.

What is claimed is:

1. A counterfeit product detection method comprising the acts of:
providing a manufacturer for producing a first product known to be authentic;
providing the manufacturer with a manufacturer's identification number and wherein the manufacturer creates a sequential serial number for the first product,
an encrypted radio frequency identification tag provided by the manufacturer that is joined to the first product;
providing the radio frequency identification tag with a receiver and a transmitter;
providing a second product having a second radio frequency identification tag wherein the authenticity of the second product is unknown and the second product is potentially an imitation;
providing a smart phone having a radio frequency identification reader and sending a radio signal from the radio frequency identification reader to the second radio frequency identification tag and energizing the second radio frequency identification tag joined to the second product the authenticity of which is not known;
transmitting an encrypted response signal message from the second radio frequency identification tag to the radio frequency identification reader;
transmitting the encrypted response signal message to the manufacturer and the manufacturer decrypts the encrypted response signal message and determines whether or not the encrypted response signal message pertaining to the second product is indicative of an authentic second product or a counterfeit second product.

2. The counterfeit product detection method according to claim 1 further comprising the act of the manufacturer informing the consumer as to whether or not second product for which the authenticity is unknown is or is not authentic.

3. The counterfeit product detection method according to claim 2 wherein the act of the manufacturer informing the consumer is by way of at least one of the following: e-mail and text message.

4. The counterfeit product detection method according to claim 1 further comprising the acts of having the consumer obtain a permanent personal identification number in advance of purchasing the product for which the authenticity is unknown and providing a national registry office for generating the permanent personal identification number, and if the second product is determined to be counterfeit, the manufacturer communicates with the consumer and gathers information such that it can investigate the origin of the counterfeit second product.

5. A system for determining whether or not a product is counterfeit comprising:
a programmed manufacturer general purpose computer having a central processing unit and a memory component;
storing sequential serial number data pertaining to a first product that is non-counterfeit that includes manufacturer identification number data, model and model number data pertaining to the first product that is non-counterfeit, country of origin data and date of manufacture data pertaining to the first product that is non-counterfeit in the memory component;
an encrypted radio frequency identification tag manufactured by the manufacturer and joined to the first product that is non-counterfeit;
providing the programmed manufacturer general purpose computer preprogrammed with decryption software for decrypting messages;
providing the radio frequency identification tag with a receiver and a transmitter;
providing a second product having a second radio frequency identification tag wherein the authenticity of the second product is unknown and the second product is potentially an imitation;
providing a smart phone having a radio frequency identification reader and sending a radio signal from the radio frequency identification reader to the second radio frequency identification tag and energizing the second radio frequency identification tag for the second product the authenticity of which is not known;
transmitting an encrypted response signal message from the second radio frequency identification tag to the radio frequency identification reader;
transmitting the encrypted response signal message to the manufacturer, wherein the manufacturer decrypts the encrypted response signal message and determines whether or not the encrypted response signal message from the second radio frequency identification tag is indicative of an authentic second product or a counterfeit second product.

6. A counterfeit product detection method comprising the acts of:
providing a manufacturer for producing a first product known to be authentic;
providing the manufacturer with a manufacturer identification number and wherein the manufacturer creates a sequential serial number for the first product,
the manufacturer disposing a visible two dimensional barcode on the first product;
providing a second product having a second two dimensional bar code disposed thereon wherein the authenticity of the second product is unknown;
providing a smart phone that includes an optical scanner and includes the associated interpretive software that is required to read two dimensional barcodes;
using the optical scanner to read the two dimensional barcode on the second product such that the optical scanner reads the encrypted product data associated with the two dimensional bar;
transmitting the encrypted product data associated with the second product to the manufacturer and the manufacturer decrypts the encrypted product data and determines whether or not the encrypted product data pertaining to the second product is indicative of an authentic second product or a counterfeit second product.

7. The counterfeit product detection method according to claim 6 further including the acts of:
the manufacturer informing the consumer as to whether or not second product for which the authenticity is unknown is or is not authentic.

8. The counterfeit product detection method according to claim 7 wherein the act of the manufacturer informing the consumer is by way of at least one of the following: e-mail and text message.

9. The counterfeit product detection method according to claim 6 further comprising the acts of having the consumer obtain a permanent personal identification number in advance of purchasing the product for which the authenticity is unknown and providing a national registry office for generating the permanent personal identification number and if the second product is determined to be counterfeit the manufacture communicates with the consumer and gathers information such that it can investigate the origin of the counterfeit second product.
